(19) United States
(12) Patent Application Publication
(10) Pub. No.: US 2022/0227110 A1
(43) Pub. Date: Jul. 21, 2022

(54) Hybrid-type fiber-reinforced composite material and apparatus for producing same

(71) Applicant: LG HAUSYS, LTD., Seoul (KR)

(72) Inventors: Ae Ri Oh, Seoul (KR); Hee June Kim, Seoul (KR)

(21) Appl. No.: 17/615,230

(22) PCT Filed: Aug. 12, 2020
(86) PCT No.: PCT/KR2020/010650

§ 371 Date: Nov. 30, 2021

(30) Foreign Application Priority Data
Aug. 20, 2019 (KR) 10-2019-0101934
Aug. 4, 2020 (KR) 10-2020-0097630

(51) Int. Cl. B32B 27/12; B32B 5/26; B32B 5/02; B32B 27/38; B32B 27/36; B32B 27/30; B32B 37/00; B32B 37/10; B32B 37/24; B32B 38/00

(52) U.S. Cl. CPC B32B 27/12; B32B 2307/546; B32B 5/024; B32B 27/38; B32B 27/36; B32B 27/308; B32B 37/025; B32B 37/10; B32B 37/24; B32B 38/0004; B32B 2260/023; B32B 2260/046; B32B 2307/732; B32B 2262/101; B32B 2262/106; B32B 2307/718; B32B 5/263

(57) ABSTRACT

A hybrid fiber-reinforced composite material according to an aspect of the present disclosure may comprise a first continuous fiber layer, a long fiber layer laminated on one surface of the first continuous fiber layer, and a second continuous fiber layer laminated on one surface of the long fiber layer, and may further comprise at least one of a first thermosetting resin laminated on the other surface of the first continuous fiber layer and a second thermosetting resin laminated on one surface of the second continuous fiber layer.

### BACKGROUND OF THE DISCLOSURE

### Field of the Disclosure

The present disclosure relates to a hybrid fiber-reinforced composite material and an apparatus for manufacturing the same.

### Related Art

In general, automobile parts are manufactured with metal materials to secure high strength and high stiffness.

However, in the case of automobile parts made of metal, manufacturing costs are high during processing, and as the weight increases, it is difficult to secure weight reduction.

In order to overcome this problem, weight reduction is secured by manufacturing automobile parts using plastic materials composed of reinforcing fibers and resin matrices instead of metal.

Meanwhile, plastics composed of reinforcing fibers and resin matrices exhibit light weight, high strength, and high stiffness by adjusting the content, type, etc. of the fibers. It is difficult to indicate weight reduction when the content of the fibers exceeds an appropriate range, a composite containing only long fibers has excellent formability, while it is difficult for the composite to exhibit high strength, and a composite containing only continuous fibers has excellent strength and stiffness, while there is a problem in that it has weak formability compared to the composite containing the long fibers.

### SUMMARY

An object of the present disclosure is to provide a hybrid fiber-reinforced composite material which is applicable to structural parts requiring stiffness to which metal is applied, combines fluidity by long fibers and stiffness by continuous fibers, secures fluidity to improve formability and have excellent strength and hardness at the same time, and is capable of reducing dispersion according to the location of a product by simultaneously injecting the continuous fibers, and an apparatus for manufacturing the same.

A hybrid fiber-reinforced composite material according to an aspect of the present disclosure may comprise a first long fiber layer, a continuous fiber layer laminated on one surface of the first long fiber layer, and a second long fiber layer laminated on one surface of the continuous fiber layer, and may further comprise at least one of a first thermosetting resin laminated on the other surface of the first long fiber layer and a second thermosetting resin laminated on one surface of the second long fiber layer.

The first thermosetting resin and the second thermosetting resin may each include at least one of epoxy, unsaturated polyester, and vinyl ester.

The first long fiber layer and the second long fiber layer may each have a thickness of 0.3 to 1 mm, and the continuous fiber layer may have a thickness of 0.3 to 0.7 mm.

The first long fiber layer, the continuous fiber layer, and the second long fiber layer may each comprise at least one of glass fiber and carbon fiber.

The hybrid fiber-reinforced composite material may have a basis weight of 1,000 to 4,000 gsm, and the at least one of glass fiber and carbon fiber may have a weight ratio of 25 to 70% of the hybrid fiber-reinforced composite material.

A hybrid fiber-reinforced composite material according to another aspect of the present disclosure may comprise a first continuous fiber layer, a long fiber layer laminated on one surface of the first continuous fiber layer, and a second continuous fiber layer laminated on one surface of the long fiber layer, and may further comprise at least one of a first thermosetting resin laminated on the other surface of the first continuous fiber layer and a second thermosetting resin laminated on one surface of the second continuous fiber layer.

The first thermosetting resin and the second thermosetting resin may each include at least one of epoxy, unsaturated polyester, and vinyl ester.

The long fiber layer may have a thickness of 0.3 to 1 mm, and the first continuous fiber layer and the second continuous fiber layer may each have a thickness of 0.3 to 0.7 mm.

The first long fiber layer and the second long fiber layer may each comprise at least one of glass fiber and carbon fiber.

The hybrid fiber-reinforced composite material may have a basis weight of 1,000 to 4,000 gsm, and the at least one of glass fiber and carbon fiber may have a weight ratio of 25 to 70% of the hybrid fiber-reinforced composite material.

An apparatus for manufacturing a hybrid fiber-reinforced composite material according to an aspect of the present disclosure may include a first thermosetting resin supply unit for discharging a first thermosetting resin, a first long fiber supply unit for supplying a first long fiber to the top portion of the first thermosetting resin, a continuous fiber supply unit including a supply roll for supplying a continuous fiber to the top portion of the first long fiber, a second long fiber supply unit for supplying a second long fiber to the top portion of the continuous fiber, a second thermosetting resin supply unit for supplying a second thermosetting resin to the top portion of the second long fiber, a conveying belt unit for moving them so that the first thermosetting resin, the first long fiber, the continuous fiber, the second long fiber, and the second thermosetting resin are sequentially stacked, and a winding roll unit for receiving and winding a composite material composed of the first thermosetting resin, the first long fiber, the continuous fiber, the second long fiber, and the second thermosetting resin, which are sequentially stacked, from the conveying belt unit.

The first long fiber supply unit and the second long fiber supply unit may each include a support roll for supporting a glass fiber or carbon fiber roving and a cutting roll for cutting the glass fiber or carbon fiber roving.

The conveying belt unit may include a belt for moving them so that the first thermosetting resin, the first long fiber, the continuous fiber, the second long fiber, and the second thermosetting resin are sequentially stacked and a transfer for providing a driving force to the belt.

The conveying belt unit may further include a pressurizing and supporting roll for pressurizing the second thermosetting resin supplied and stacked by the second thermosetting resin supply unit.

An apparatus for manufacturing a hybrid fiber-reinforced composite material according to another aspect of the present disclosure may include a first thermosetting resin supply unit for discharging a first thermosetting resin, a first continuous fiber supply unit including a supply roll for supplying a first continuous fiber to the top portion of the first thermosetting resin, a long fiber supply unit for supplying a long fiber to the top portion of the first continuous fiber, a second continuous fiber supply unit including a supply roll for supplying a second continuous fiber to the top portion of the long fiber, a second thermosetting resin supply unit for supplying a second thermosetting resin to the top portion of the second continuous fiber, a conveying belt unit for moving them so that the first thermosetting resin, the first continuous fiber, the long fiber, the second continuous fiber, and the second thermosetting resin are sequentially stacked, and a winding roll unit for receiving and winding a composite material composed of the first thermosetting resin, the first continuous fiber, the long fiber, the second continuous fiber, and the second thermosetting resin, which are sequentially stacked, from the conveying belt unit.

The long fiber supply unit may include a support roll for supporting a glass fiber or carbon fiber roving and a cutting roll for cutting the glass fiber or carbon fiber roving.

The conveying belt unit may include a belt for moving them so that the first thermosetting resin, the first continuous fiber, the long fiber, the second continuous fiber, and the second thermosetting resin are sequentially stacked and a transfer roll for providing a driving force to the belt.

The conveying belt unit may further include a pressurizing and supporting roll for pressurizing the second thermosetting resin, which is supplied and stacked, by the second thermosetting resin supply unit.

### ADVANTAGEOUS EFFECTS

According to the foregoing hybrid fiber-reinforced composite material of the present disclosure and an apparatus for manufacturing the same, it is applicable to structural parts requiring stiffness to which metal is applied, and fluidity by long fibers and stiffness by continuous fibers can be combined.

Further, fluidity is secured so that formability is improved, and at the same time excellent strength and hardness can be obtained.

Further, dispersion according to the location of the product can be reduced by simultaneously injecting the continuous fibers.

### BRIEF DESCRIPTION OF THE DRAWINGS

FIG. 1 is a configuration diagram schematically showing a hybrid fiber-reinforced composite material according to a first embodiment of the present disclosure.

FIG. 2 is a configuration diagram schematically showing a hybrid fiber-reinforced composite material according to a second embodiment of the present disclosure.

FIG. 3 is a flowchart schematically showing a method for manufacturing the hybrid fiber-reinforced composite material according to the first embodiment of the present disclosure shown in FIG. 1.

FIG. 4 is a configuration diagram schematically showing an apparatus for manufacturing the hybrid fiber-reinforced composite material according to the first embodiment of the present disclosure.

FIG. 5 is a flowchart schematically showing a method for manufacturing the hybrid fiber-reinforced composite material according to the second embodiment of the present disclosure shown in FIG. 2.

FIG. 6 is a configuration diagram schematically showing an apparatus for manufacturing the hybrid fiber-reinforced composite material according to the second embodiment of the present disclosure.

### DESCRIPTION OF EXEMPLARY EMBODIMENTS

Since the present disclosure can apply various changes and can have various embodiments, specific embodiments will be illustrated and described in detail in the detailed description. However, this is not intended to limit the present disclosure to specific embodiments, and it should be understood that all modifications, equivalents, and substitutes included in the spirit and technical scope of the present disclosure are included.

Terms used in the present disclosure are used for the purpose of describing specific embodiments only, and should not be construed as an intention of limiting the present disclosure. An expression of the singular number includes an expression of the plural number unless clearly defined otherwise in the context. In the present disclosure, it should be understood that a term such as “comprises” or “having” is used to specify existence of a feature, a number, a step, an operation, an element, a part, or a combination thereof described in the specification, but it does not preclude the possibility of the existence or addition of one or more other features, numbers, steps, operations, elements, parts, or combinations thereof.

Hereinafter, preferred embodiments of the present disclosure will be described in detail with reference to the accompanying drawings. At this time, it should be noted that the same elements in the accompanying drawings are denoted by the same reference numerals as much as possible. Further, detailed descriptions of well-known functions and configurations that may obscure the gist of the present disclosure will be omitted. For the same reason, some elements are exaggerated, omitted, or schematically illustrated in the accompanying drawings.

Hereinafter, a hybrid fiber-reinforced composite material according to a first embodiment of the present disclosure will be described.

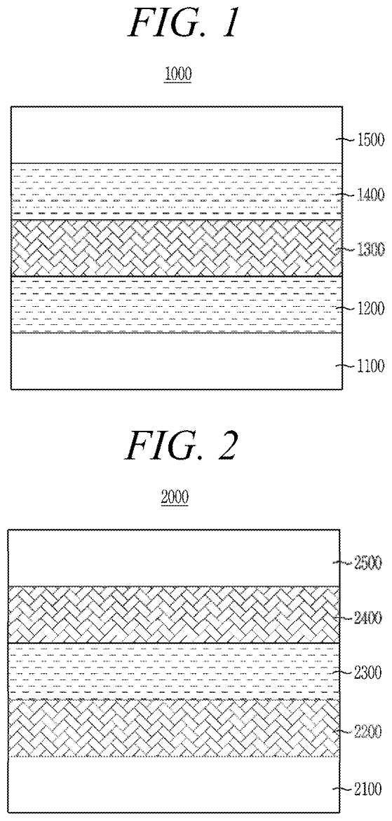

FIG. 1 is a configuration diagram schematically showing a hybrid fiber-reinforced composite material according to a first embodiment of the present disclosure.

Referring to FIG. 1, a hybrid fiber-reinforced composite material 1000 may comprise a first thermosetting resin 1100, a first long fiber layer 1200, a continuous fiber layer 1300, a second long fiber layer 1400, and a second thermosetting resin (1500).

Specifically, the hybrid fiber-reinforced composite material 1000 may comprise the first long fiber layer 1200, the continuous fiber layer 1300 laminated on one surface of the first long fiber layer, and the second long fiber layer 1400 laminated on one surface of the continuous fiber layer, and may further comprise at least one of the first thermosetting resin 1100 laminated on the other surface of the first long fiber layer 1200 and the second thermosetting resin 1500 laminated on one surface of the second long fiber layer 1400.

Based on the direction shown in FIG. 1, the continuous fiber layer 1300 may be laminated on the top surface of the first long fiber layer 1200, and the second long fiber layer 1400 may be laminated on the top surface of the continuous fiber layer 1300. That is, the continuous fiber layer 1300 may be disposed between the first long fiber layer 1200 and the second long fiber layer 1400.

Long fibers are made in the form of the yarn after passing the polymer through a spinning process of pulling out a yarn and a stretching process of giving various physical properties after obtaining a polymer in the form of a gel when a polymerization reaction occurs while applying heat and pressure to, for example, high-purity terephthalic acid (PTA) and ethylene glycol (EG) which are raw materials of polyester. Fibers cut to a length of 1 to 2 inches may be used as the long fibers. The long fibers are cut to a longer length than short fibers.

As continuous fibers, the fibers made in the form of the yarn by performing the above-mentioned spinning and stretching processes may be used as they are, or woven fabrics may be used.

Meanwhile, the first thermosetting resin 1100 may be disposed on the bottom surface of a fiber layer sheet in which the first long fiber layer 1200, the continuous fiber layer 1300, and the second long fiber layer 1400 are sequentially stacked, the second thermosetting resin 1500 may be disposed on the top surface of the fiber layer sheet, or the first thermosetting resin 1100 may be disposed on the bottom surface of the fiber layer sheet and the second thermosetting resin 1500 may be disposed on the top surface of the fiber layer sheet at the same time.

The first long fiber layer 1200 may be impregnated in a liquid phase first thermosetting resin 1100 before the first thermosetting resin 1100 is cured, and the second long fiber layer 1400 may also be impregnated in a liquid phase second thermosetting resin 1500 before the second thermosetting resin 1500 is cured. At least a portion of the continuous fiber layer 1300 may also be impregnated in the liquid phase thermosetting resins 1100 and 1500 by thermocompression bonding.

The first thermosetting resin 1100 and the second thermosetting resin 1500 may each include at least one of epoxy, unsaturated polyester, and vinyl ester. The thermosetting resin is supplied in the liquid phase before curing, and is thermocompression bonded along with long fibers and continuous fibers so that the thermosetting resin may penetrate into the long fibers and the continuous fibers. Therefore, it may become SMC (Sheet Molding Compound) as a hybrid fiber-reinforced composite material in which the thermosetting resin and a pair of the long fibers and the continuous fibers are integrated.

The first long fiber layer 1200 and the second long fiber layer 1400 may each have a thickness of 0.3 to 1 mm, and the continuous fiber layer 1300 may have a thickness of 0.3 to 0.7 mm.

The thickness of the first long fiber layer 1200 and the second long fiber layer 1400 means the thickness of a long fiber composite layer impregnated with the thermosetting resin, and may be 0.3 mm or more. Although the long fiber layer may have a maximum thickness of 1 mm, it may have a thickness greater than 1 mm depending on the thickness of a part to be made of the fiber-reinforced composite material.

The thickness of the continuous fiber layer 1300 also refers to the thickness of a continuous fiber composite layer impregnated with the thermosetting resin, and may be 0.3 to 0.7 mm. Since it is preferable to use a fabric for the continuous fiber layer 1300, the maximum thickness value of the continuous fiber layers may be smaller than that of the long fiber layer.

The first long fiber layer 1200, the continuous fiber layer 1300, and the second long fiber layer 1400 may each comprise at least one of glass fiber and carbon fiber.

Glass fiber is made when glass melted in a platinum crucible is pulled out through a small hole in the crucible at a high speed. About 1/200 thick thin fibers made in this way are much stronger in heat or chemicals than plate glass or glass bowl and have high elasticity. Further, it is being used in various fields by using heat resistance, chemical resistance, elasticity resistance, etc. possessed by glass fiber. A glass fiber reinforced plastic is manufactured by mixing glass fiber with plastics.

Carbon fiber is a very thin fiber with a thickness of 0.005 to 0.010 mm whose main component is carbon. Carbon atoms constituting the carbon fiber are attached in the form of hexagonal ring crystals along the length direction of the fiber, and due to this molecular arrangement structure, it has strong physical properties. One strand of yarn is made by twisting a thousand strands of the carbon fiber. The carbon fiber may be woven in various patterns, and may be used together with plastics and the like so that lightweight and strong composite materials such as carbon fiber reinforced plastic (carbon fiber reinforced polymer) are manufactured. Since the density of the carbon fiber is much lower than that of iron, it is suitable to use the carbon fiber when weight reduction is an essential condition. The carbon fiber may be very widely used as a material in the aerospace industry, civil engineering and construction, military, automobile, and various sports fields due to characteristics such as high tensile strength, light weight, low thermal expansion rate, etc.

The hybrid fiber-reinforced composite material 1000 may have a basis weight of 1,000 to 4,000 gsm, and at least one of glass fiber and carbon fiber may have a weight ratio of 25 to 70% of the hybrid fiber-reinforced composite material.

At this time, the unit of the basis weight is gsm (grams per square meter), which refers to the weight (g) of a sheet of 1 m in width and 1 m in length. The hybrid fiber-reinforced composite material 1000 composed of fibers and a thermosetting resin may have a basis weight of 1,000 to 4,000 gsm depending on the content and thickness of the components.

The weight of the first long fiber layer 1200, the continuous fiber layer 1300, and the second long fiber layer 1400 of the hybrid fiber-reinforced composite material 1000 may be 25 to 70% of the total weight. For example, the first long fiber layer 1200, the continuous fiber layer 1300, and the second long fiber layer 1400 may be comprised of 60% by weight of carbon fiber, and the first thermosetting resin 1100 and the second thermosetting resin 1500 may be comprised of 40% by weight of unsaturated polyester.

The hybrid fiber-reinforced composite material 1000 according to the first embodiment of the present disclosure may secure excellent strength and stiffness and secure desired mechanical properties, and may be secondary-molded using SMC to manufacture a part with a specific form.

Hereinafter, a hybrid fiber-reinforced composite material according to a second embodiment of the present disclosure will be described.

FIG. 2 is a configuration diagram schematically showing a hybrid fiber-reinforced composite material according to a second embodiment of the present disclosure.

Referring to FIG. 2, the hybrid fiber-reinforced composite material 2000 may comprise a first thermosetting resin 2100, a first continuous fiber layer 2200, a long fiber layer 2300, a second continuous fiber layer 2400, and a second thermosetting resin (2500).

Specifically, the hybrid fiber-reinforced composite material 2000 may comprise the first continuous fiber layer 2200, the long fiber layer 2300 laminated on one surface of the first long fiber layer, and the second continuous fiber layer 2400 laminated on one surface of the continuous fiber layer, and may further comprise at least one of the first thermosetting resin 2100 laminated on the other surface of the first continuous fiber layer 2200 and the second thermosetting resin 2500 laminated on one surface of the second continuous fiber layer 2400.

Based on the direction shown in FIG. 2, the long fiber layer 2300 may be laminated on the top surface of the first continuous fiber layer 2200, and the second continuous fiber layer 2400 may be laminated on the top surface of the long fiber layer 2300. That is, the long fiber layer 2300 may be disposed between the first continuous fiber layer 2200 and the second continuous fiber layer 2400.

Long fibers are made in the form of the yarn after passing the polymer through a spinning process of pulling out a yarn and a stretching process of giving various physical properties after obtaining a polymer in the form of a gel when a polymerization reaction occurs while applying heat and pressure to, for example, high-purity terephthalic acid (PTA) and ethylene glycol (EG) which are raw materials of polyester. Fibers cut to a length of 1 to 2 inches may be used as the long fibers. The long fibers are cut to a longer length than short fibers.

As continuous fibers, the fibers made in the form of the yarn by performing the above-mentioned spinning and stretching processes may be used as they are, or woven fabrics may be used.

The first thermosetting resin 2100 may be disposed on the bottom surface of a fiber layer sheet in which the first continuous fiber layer 2200, the long fiber layer 2300, and the second continuous fiber layer 2400 are sequentially stacked, the second thermosetting resin 2500 may be disposed on the top surface of the fiber layer sheet, or the first thermosetting resin 2100 may be disposed on the bottom surface of the fiber layer sheet and the second thermosetting resin 2500 may be disposed on the top surface of the fiber layer sheet at the same time.

The first continuous fiber layer 2200 may be impregnated in a liquid phase first thermosetting resin 2100 before the first thermosetting resin 1100 is cured, and the second continuous fiber layer 2400 may also be impregnated in a liquid phase second thermosetting resin 2500 before the second thermosetting resin 2500 is cured. At least a portion of the long fiber layer 2300 may also be impregnated in the liquid phase thermosetting resins 2100 and 2500 by thermocompression bonding.

The first thermosetting resin 2100 and the second thermosetting resin 2500 may each include at least one of epoxy, unsaturated polyester, and vinyl ester. The thermosetting resin is supplied in the liquid phase before curing, and is thermocompression bonded along with long fibers and continuous fibers so that the thermosetting resin may penetrate into the long fibers and the continuous fibers. Therefore, it may become SMC (Sheet Molding Compound) as a hybrid fiber-reinforced composite material in which the thermosetting resin and a pair of the long fibers and the continuous fibers are integrated.

The long fiber layer 2300 may have a thickness of 0.3 to 1 mm, and the first continuous fiber layer 2200 and the second continuous fiber layer 2400 may each have a thickness of 0.3 to 0.7 mm.

The thickness of the long fiber layer 2300 refers to the thickness of a long fiber composite layer impregnated with the thermosetting resin, and may be 0.3 mm or more. Although the long fiber layer may have a maximum thickness of 1 mm, it may have a thickness greater than 1 mm depending on the thickness of a part to be made of the fiber-reinforced composite material.

The thickness of the first continuous fiber layer 2200 and the second continuous fiber layer 2400 also refers to the thickness of a continuous fiber composite layer impregnated with the thermosetting resin, and may each be 0.3 to 0.7 mm. Since it is preferable to use a fabric for the long fiber layer 2300, the maximum thickness value of the continuous fiber layers may be smaller than that of the long fiber layer.

The first continuous fiber layer 2200, the long fiber layer 2300, and the second continuous fiber layer 2400 may each comprise at least one of glass fiber and carbon fiber.

Glass fiber is made when glass melted in a platinum crucible is pulled out through a small hole in the crucible at a high speed. About 1/200 thick thin fibers made in this way are much stronger in heat or chemicals than plate glass or glass bowl and have high elasticity. Further, it is being used in various fields by using heat resistance, chemical resistance, elasticity resistance, etc. possessed by glass fiber. A glass fiber reinforced plastic is manufactured by mixing glass fiber with plastics.

Carbon fiber is a very thin fiber with a thickness of 0.005 to 0.010 mm whose main component is carbon. Carbon atoms constituting the carbon fiber are attached in the form of hexagonal ring crystals along the length direction of the fiber, and due to this molecular arrangement structure, it has strong physical properties. One strand of yarn is made by twisting a thousand strands of the carbon fiber. The carbon fiber may be woven in various patterns, and may be used together with plastics and the like so that lightweight and strong composite materials such as carbon fiber reinforced plastic (carbon fiber reinforced polymer) are manufactured. Since the density of the carbon fiber is much lower than that of iron, it is suitable to use the carbon fiber when weight reduction is an essential condition. The carbon fiber may be very widely used as a material in the aerospace industry, civil engineering and construction, military, automobile, and various sports fields due to characteristics such as high tensile strength, light weight, low thermal expansion rate, etc.

The hybrid fiber-reinforced composite material 2000 may have a basis weight of 1,000 to 4,000 gsm, and at least one of glass fiber and carbon fiber may have a weight ratio of 25 to 70% of the hybrid fiber-reinforced composite material.

At this time, the unit of the basis weight is gsm (grams per square meter), which refers to the weight (g) of a sheet of 1 m in width and 1 m in length. The hybrid fiber-reinforced composite material 1000 composed of fibers and a thermosetting resin may have a basis weight of 1,000 to 4,000 gsm depending on the content and thickness of the components.

The weight of the first continuous fiber layer 2200, the long fiber layer 2300, and the second continuous fiber layer 2400 of the hybrid fiber-reinforced composite material 1000 may be 25 to 70% of the total weight. For example, the first continuous fiber layer 2200, the long fiber layer 2300, and the second continuous fiber layer 2400 may be comprised of 60% by weight of carbon fiber, and the first thermosetting resin 2100 and the second thermosetting resin 2500 may be comprised of 40% by weight of unsaturated polyester.

Next, the flexural strength and flexural stiffness of a hybrid fiber-reinforced composite material SMC according to an embodiment of the present disclosure will be described in comparison with those of a long fiber SMC and a continuous fiber SMC.

In Table 1, the long fiber SMC of Comparative Example 1, as an SMC manufactured by impregnating only long fibers without continuous fibers, is made by using 50% by weight of carbon fiber and a thermosetting resin.

The continuous fiber SMC of Comparative Example 2, as an SMC manufactured by impregnating only continuous fiber fabrics without long fibers, is made by using 70% by weight of carbon fiber and a thermosetting resin.

The hybrid SMC of Example 1 is made by using a first long fiber layer, a continuous fiber layer, a second long fiber layer, and a thermosetting resin composed of 60% by weight of carbon fiber.

The hybrid SMC of Example 2 is made by using a first continuous fiber layer, a long fiber layer, a second continuous fiber layer, and a thermosetting resin composed of 60% by weight of carbon fiber.

TABLE 1

| | | Comparative | Comparative | | |
|---|---|---|---|---|---|
| | | Example 1 | Example 2 | Example 1 | Example 2 |
| | | Long fiber | Continuous fiber | Hybrid | Hybrid |
| | | SMC (50% by | SMC (70% by | SMC-1 (60% by | SMC-2 (60% by |
| Classification | | weight of CF) | weight of CF) | weight of CF) | weight of CF) |
| Flexural | On Strand (Non Flow) | 240 | 700 | 480 | 560 |
| strength | Out of Strand (Flow) | 250 | 690 | 485 | 555 |
| (MPa) | | | | | |

| | | | | |
|---|---|---|---|---|
| Flexural stiffness (GPa) | 16 | 60 | 35 | 40 |

The flexural strength represents a flexural strength of a sheet portion (on strand) within the 0.5 m×0.5 m size and a flexural strength of a sheet portion (out of strand) outside the 0.5 m×0.5 m size when a sheet with a 0.5 m×0.5 m size is compression molded to make a sheet with a 1 m×1 m size. Non-Flow means that there is little flow of fibers within the resin, and Flow means that the fibers flow within the resin. In the case of the long fiber SMC of Comparative Example 1, the flexural strengths were measured to be 240 MPa and 250 MPa, and the flexural stiffness was measured to be 16 GPa.

In the case of the continuous fiber SMC of Comparative Example 2, the flexural strengths were measured to be 700 MPa and 690 MPa, and the flexural stiffness was measured to be 60 GPa.

The flexural strength of Comparative Example 2 including a continuous fiber fabric was much larger than Comparative Example 1. Although the difference in flexural strength between the inside and outside of the strand is the same as 10 MPa in both Comparative Examples 1 and 2, it may be evaluated that there is a relatively large difference in Comparative Example 1 with a small absolute value. Comparative Example 2 having a flexural stiffness of 60 GPa was much better than Comparative Example 1 having a flexural stiffness of 16 GPa.

Therefore, it can be seen that the continuous fiber SMC of Comparative Example 2 is superior to the long fiber SMC of Comparative Example 1 in terms of strength and stiffness.

In the case of the hybrid SMC of Example 1, the flexural strengths were measured to be 480 MPa and 485 MPa, and the flexural stiffness was measured to be 35 GPa.

In the case of the hybrid SMC of Example 1, the flexural strengths were measured to be 560 MPa and 555 MPa, and the flexural stiffness was measured to be 40 GPa.

Example 1 and Example 2 are preferable since they both have a difference in flexural strength between the inside and outside of the strand of 5 MPa, which is smaller than those of Comparative Examples. In the case of Example 2, both flexural strength and flexural stiffness exhibited superior values than those of Example 1. This is because the SMC of the second embodiment in which a pair of continuous fiber layers are disposed on both sides may have superior strength and stiffness than the SMC of the first embodiment in which only one continuous fiber layer is disposed.

The strength and stiffness of the hybrid SMC of Example 2 exhibited smaller values than the continuous fiber SMC of Comparative Example 2. However, in the case of Comparative Example 2, carbon fiber was contained more than 60% by weight of Example 2 as 70% by weight, and in the case of composing the reinforcing material only with a continuous fiber fabric, the material cost will be higher and the formability may deteriorate that much.

Consequently, the hybrid SMC of the second embodiment is most preferable in terms of strength, stiffness, cost, formability, etc.

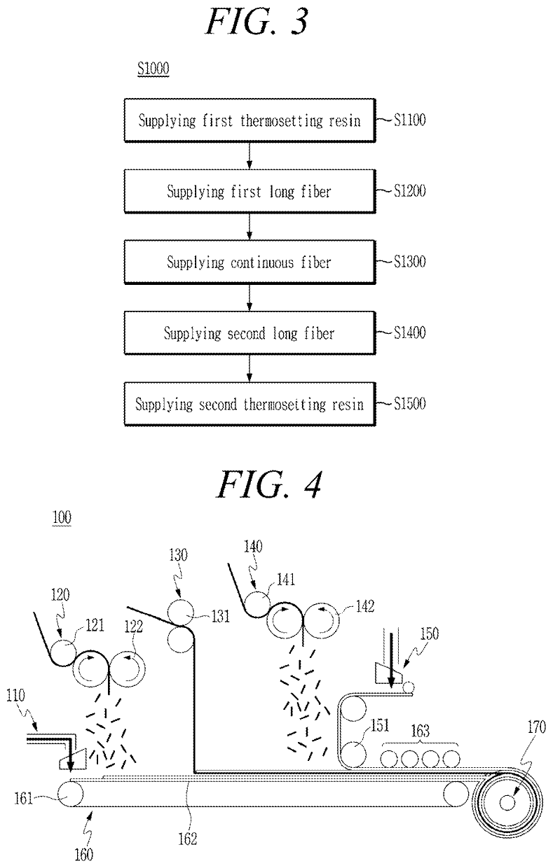

Hereinafter, a method for manufacturing a hybrid fiber-reinforced composite material according to a first embodiment of the present disclosure will be described with reference to FIG. 3.

FIG. 3 is a flowchart schematically showing a method for manufacturing the hybrid fiber-reinforced composite material according to the first embodiment of the present disclosure shown in FIG. 1.

Referring to FIG. 3, the method for manufacturing the hybrid fiber-reinforced composite material (S1000) comprises a first thermosetting resin supply step (S1100), a first long fiber supply step (S1200), a continuous fiber supply step (S1300), a second long fiber supply step (S1400), and a second thermosetting resin supply step (S1500).

Specifically, the first thermosetting resin supply step (S1100) is a step of supplying a thermosetting resin forming the lowermost layer in order to manufacture an SMC (Sheet Molding Compound) that is a composite material. Further, the thermosetting resin may include at least one of epoxy, unsaturated polyester, and vinyl ester.

The first long fiber supply step (S1200) is a step of supplying the first long fiber to the top portion of the thermosetting resin. Further, the first long fiber supply step (S1200) may cut a continuous glass fiber or carbon fiber roving and supply the cut continuous glass fiber or carbon fiber roving.

The continuous fiber supply step (S1300) is a step of supplying a continuous fiber to the top portion of the first long fiber. The continuous fiber may be made of a glass fiber or carbon fiber fabric.

Next, the second long fiber supply step (S1400) is a step of supplying a second long fiber to the top portion of the continuous fiber. Further, the second long fiber supply step (S1400) may cut a continuous carbon fiber roving and supply the cut continuous carbon fiber roving.

The second thermosetting resin supply step (S1500) is a step of supplying the thermosetting resin to the top portion of the second long fiber. Further, the thermosetting resin may include at least one of epoxy, unsaturated polyester, and vinyl ester.

Hereinafter, an apparatus for manufacturing a hybrid fiber-reinforced composite material according to a first embodiment of the present disclosure will be described with reference to FIG. 4.

FIG. 4 is a configuration diagram schematically showing an apparatus for manufacturing the hybrid fiber-reinforced composite material according to the first embodiment of the present disclosure.

Referring to FIG. 4, the apparatus for manufacturing the hybrid fiber-reinforced composite material 100 includes a first thermosetting resin supply unit 110, a first long fiber supply unit 120, a continuous fiber supply unit 130, a second long fiber supply unit 140, a second thermosetting resin supply unit 150, a conveying belt unit 160, and a winding roll unit 170.

The first thermosetting resin supply unit 110 is to provide the first thermosetting resin, and is positioned to discharge the first thermosetting resin toward the conveying belt unit 160.

The first long fiber supply unit 120 supplies the first long fiber to the first thermosetting resin. The first long fiber supply unit 120 may cut the glass fiber or carbon fiber roving into a long fiber form and supply it to be dispersed on the top surface of the first thermosetting resin that is moved.

The first long fiber supply unit 120 is for providing the first long fiber to the top portion of the first thermosetting resin. To this end, the first long fiber supply unit 120 may be disposed after the first thermosetting resin supply unit 110 with respect to the belt transfer direction of the conveying belt unit 160.

The first long fiber supply unit 120 may include a support roll 121 for supporting the glass fiber or carbon fiber roving and a cutting roll 122 for cutting the glass fiber or carbon fiber roving. The cutting roll 122 may include a first cutting roll for guiding the glass fiber or carbon fiber roving between the support roll 121 and the first cutting roll and a second cutting roll which has a plurality of cutting blades formed on the circumferential surface thereof and supplies long cut fibers between the first cutting roll and the second cutting roll.

The continuous fiber supply unit 130 is for supplying a continuous fiber to the top portion of the first long fiber transferred through the conveying belt unit 160, and may include a pair of supply rolls 131 for supplying the continuous fiber.

The continuous fiber supply unit 130 may be disposed after the first long fiber supply unit 120 with respect to the belt transfer direction of the conveying belt unit 160.

The second long fiber supply unit 140 supplies the second long fiber to the top portion of the continuous fiber transferred through the conveying belt unit 160.

The second long fiber supply unit 140 may also include a support roll 141 or supporting the glass fiber or carbon fiber roving and a cutting roll 142 for cutting the glass fiber or carbon fiber roving.

Further, the second long fiber supply unit 140 may be disposed after the continuous fiber supply unit 130 with respect to the belt transfer direction of the conveying belt unit 160.

The second thermosetting resin supply unit 150 is for supplying the second thermosetting resin to the second long fiber. The second thermosetting resin supply unit 150 may include a support roll 151 in order to stably supply the second thermosetting resin. The support roll 151 may be disposed to face a belt 162 of the conveying belt unit 160. A plurality of the support rolls 151 may be disposed so as to change the transfer direction of the second thermosetting resin.

Further, the second thermosetting resin supply unit 150 may be disposed after the second long fiber supply unit 140 with respect to the belt transfer direction of the conveying belt unit.

The conveying belt unit 160 may include a transfer roll 161 and a belt 162.

The belt 162 is connected to the transfer roll 161 and circulated, and the belt 162 moves them so that the first thermosetting resin, the first long fiber, the continuous fiber, the second long fiber, and the second thermosetting resin are sequentially stacked.

That is, the transfer roll 161 provides a driving force to the belt 162.

Further, the belt 162 transfers the first thermosetting resin, the first long fiber, the continuous fiber, the second long fiber, and the second thermosetting resin that have been sequentially stacked to the winding roll unit 170.

Further, the conveying belt unit 160 may further include a plurality of pressurizing and supporting rolls 163. The plurality of pressurizing and supporting rolls 163 are for forming the hybrid fiber-reinforced composite material more effectively by pressurizing the second thermosetting resin provided by the second thermosetting resin supply unit 150.

To this end, the pressurizing and supporting rolls 163 may be disposed after the second thermosetting resin supply unit 150, and may be disposed to face the belt 162 with respect to the belt transfer direction of the conveying belt unit 160.

The winding roll unit 170 is for winding the hybrid fiber-reinforced composite material flown by the conveying belt unit 160.

To this end, the winding roll unit 170 may be disposed to extend from the conveying belt unit 160 with respect to the transfer direction of the belt 162 of the conveying belt unit 160.

Accordingly, the hybrid fiber-reinforced composite material sequentially stacked on the belt 162 of the conveying belt unit 160 may be wound on the winding roll unit 170.

Further, the hybrid fiber-reinforced composite material wound on the winding roll unit 170 may be stored at low temperatures in a semi-cured state.

According to an apparatus for manufacturing the hybrid fiber-reinforced composite material according to the first embodiment of the present disclosure, an SMC in which they are sequentially integrated by impregnating the top and bottom surfaces of a sheet in which the first long fiber, the continuous fiber, and the second long fiber are sequentially stacked with the thermosetting resin may be easily manufactured.

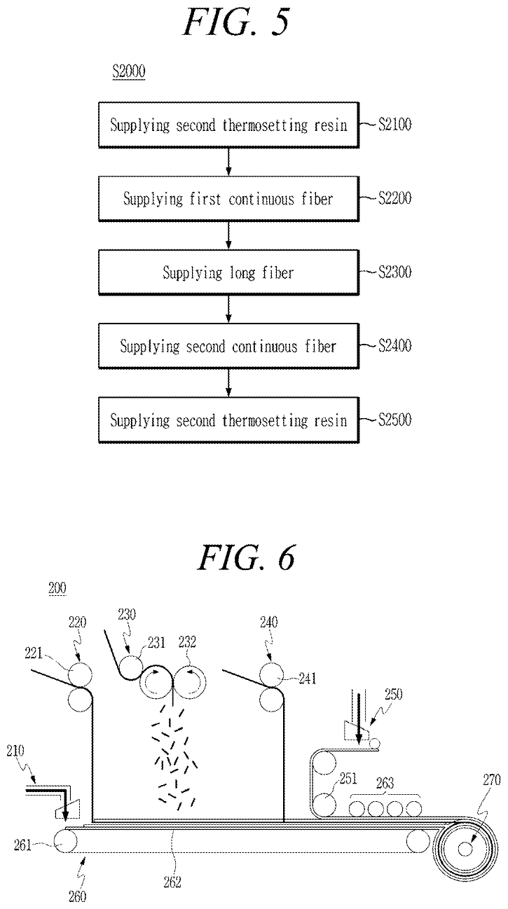

Hereinafter, a method for manufacturing the hybrid fiber-reinforced composite material according to the second embodiment of the present disclosure will be described with reference to FIG. 5.

FIG. 5 is a flowchart schematically showing a method for manufacturing the hybrid fiber-reinforced composite material according to the second embodiment of the present disclosure shown in FIG. 2.

Referring to FIG. 5, the method for manufacturing the hybrid fiber-reinforced composite material (S2000) comprises a first thermosetting resin supply step (S2100), a first continuous fiber supply step (S2200), a long fiber supply step (S2300), a second continuous fiber supply step (S2400), and a second thermosetting resin supply step (S2500).

Specifically, the first thermosetting resin supply step (S2100) is a step of supplying the thermosetting resin forming the lowermost layer in order to manufacture an SMC (Sheet Molding Compound) that is a composite material. Further, the thermosetting resin may include at least one of epoxy, unsaturated polyester, and vinyl ester.

The first continuous fiber supply step (S2200) is a step of supplying a continuous fiber to the top portion of the thermosetting resin. The continuous fiber may be made of a glass fiber or carbon fiber fabric.

The long fiber supply step (S2300) is a step of supplying a long fiber to the top portion of the first continuous fiber. Further, the long fiber supply step (S2300) may cut a continuous glass fiber or carbon fiber roving and supply the cut continuous glass fiber or carbon fiber roving.

Next, the second continuous fiber supply step (S2400) is a step of supplying the continuous fiber to the top portion of the long fiber. The continuous fiber may be made of a glass fiber or carbon fiber fabric.

The second thermosetting resin supply step (S2500) is a step of supplying the thermosetting resin to the top portion of the second continuous fiber. Further, the thermosetting resin may include at least one of epoxy, unsaturated polyester, and vinyl ester.

Hereinafter, the apparatus for manufacturing the hybrid fiber-reinforced composite material according to the second embodiment of the present disclosure will be described with reference to FIG. 6.

FIG. 6 is a configuration diagram schematically showing an apparatus for manufacturing the hybrid fiber-reinforced composite material according to the second embodiment of the present disclosure.

Referring to FIG. 6, the apparatus for manufacturing the hybrid fiber-reinforced composite material 100 includes a first thermosetting resin supply unit 210, a first continuous fiber supply unit 220, a long fiber supply unit 230, a second continuous fiber supply unit 240, a second thermosetting resin supply unit 250, a conveying belt unit 260, and a winding roll unit 270.

The first thermosetting resin supply unit 210 is to provide the first thermosetting resin, and is positioned to discharge the first thermosetting resin toward the conveying belt unit 260.

The first continuous fiber supply unit 220 is for supplying the first continuous fiber to the first thermosetting resin, and may include a pair of supply rolls 221 for supplying the continuous fiber.

The first continuous fiber supply unit 220 may be disposed after the first thermosetting resin supply unit 210 with respect to the belt transfer direction of the conveying belt unit 260.

The long fiber supply unit 230 may cut the glass fiber or carbon fiber roving into a long fiber form and supply it to be dispersed on the top surface of the first thermosetting resin that is moved.

The long fiber supply unit 230 may include a support roll 231 for supporting the glass fiber or carbon fiber roving and a cutting roll 232 for cutting the glass fiber or carbon fiber roving. The cutting roll 232 may include a first cutting roll for guiding the glass fiber or carbon fiber roving between the support roll 231 and the first cutting roll and a second cutting roll which has a plurality of cutting blades formed on the circumferential surface thereof and supplies long cut fibers between the first cutting roll and the second cutting roll.

The long fiber supply unit 230 may be disposed after the first continuous fiber supply unit 220 with respect to the belt transfer direction of the conveying belt unit 260.

The second continuous fiber supply unit 240 is for supplying the second continuous fiber to the top portion of the long fiber transferred through the conveying belt unit 260, and may include a pair of supply rolls 241 for supplying the continuous fiber.

Further, the second continuous fiber supply unit 240 may be disposed after the long fiber supply unit 230 with respect to the belt transfer direction of the conveying belt unit 260.

The second thermosetting resin supply unit 250 is for supplying the second thermosetting resin to the second continuous fiber. The second thermosetting resin supply unit 250 may include a support roll 251 in order to stably supply the second thermosetting resin. The support roll 251 may be disposed to face a belt 262 of the conveying belt unit 260. A plurality of the support rolls 251 may be disposed so as to change the transfer direction of the second thermosetting resin.

Further, the second thermosetting resin supply unit 250 may be disposed after the second continuous fiber supply unit 240 with respect to the belt transfer direction of the conveying belt unit.

The conveying belt unit 260 may include a transfer roll 261 and a belt 262.

The belt 262 is connected to the transfer roll 261 and circulated, and the belt 262 moves them so that the first thermosetting resin, the first continuous fiber, the long fiber, the second continuous fiber, and the second thermosetting resin are sequentially stacked.

That is, the transfer roll 261 provides a driving force to the belt 262.

Further, the belt 262 transfers the first thermosetting resin, the first continuous fiber, the long fiber, the second continuous fiber, and the second thermosetting resin that have been sequentially stacked to the winding roll unit 270.

Further, the conveying belt unit 260 may further include a plurality of pressurizing and supporting rolls 263. The plurality of pressurizing and supporting rolls 263 are for forming the hybrid fiber-reinforced composite material more effectively by pressurizing the second thermosetting resin provided by the second thermosetting resin supply unit 250.

To this end, the pressurizing and supporting rolls 263 may be disposed after the second thermosetting resin supply unit 250 and may be disposed to face the belt 262 with respect to the belt transfer direction of the conveying belt unit 260.

The winding roll unit 270 is for winding the hybrid fiber-reinforced composite material flown by the conveying belt unit 260.

To this end, the winding roll unit 270 may be disposed to extend from the conveying belt unit 260 with respect to the transfer direction of the belt 262 of the conveying belt unit 260.

Accordingly, the hybrid fiber-reinforced composite material sequentially stacked on the belt 262 of the conveying belt unit 260 may be wound on the winding roll unit 270.

Further, the hybrid fiber-reinforced composite material wound on the winding roll unit 270 may be stored at low temperatures in a semi-cured state.

According to the apparatus for manufacturing the hybrid fiber-reinforced composite material according to the second embodiment of the present disclosure, an SMC in which they are sequentially integrated by impregnating the top and bottom surfaces of a sheet in which the first continuous fiber, the long fiber, and the second long fiber are sequentially stacked with the thermosetting resin may be easily manufactured.

Hereinabove, an embodiment of the present disclosure has been described. However, those of ordinary skill in the art can variously modify and change the present disclosure by supplement, change, deletion, addition, or the like of constituent elements within the scope without departing from the idea of the present disclosure as set forth in the claims, and this will also be included within the right scope of the present disclosure.

[Explanation of Marks]

| | |
|---|---|
| 100: apparatus for manufacturing a hybrid | |
| fiber-reinforced composite material (first | |
| embodiment) | |
| 110: first thermosetting resin supply unit | 120: first long fiber supply unit |
| 121: support roll | 122: cutting roll |
| 130: continuous fiber supply unit | 131: supply roll |
| 140: second long fiber supply unit | 141: support roll |
| 142: cutting roll | 150: second thermosetting resin supply unit |
| 151: support roll | 160: conveying belt unit |
| 161: transfer roll | 162: belt |
| 163: pressurizing and supporting roll | 170: winding roll unit |
| 200: apparatus for manufacturing a hybrid | |
| fiber-reinforced composite material (second | |
| embodiment) | |
| 210: first thermosetting resin supply unit | 220: first continuous fiber supply unit |
| 221: supply roll | 230: long fiber supply unit |
| 231: support roll | 232: cutting roll |
| 240: second continuous fiber supply unit | 241: supply roll |
| 250: second thermosetting resin supply unit | 251: support roll |
| 260: conveying belt unit | 261: transfer roll |
| 262: belt | 263: pressurizing and supporting roll |
| 270: winding roll unit | |
| 1000: hybrid fiber-reinforced composite | |
| material (first embodiment) | |
| 1100: first thermosetting resin | 1200: first long fiber layer |
| 1300: continuous fiber layer | 1400: second long fiber layer |
| 1500: second thermosetting resin | |
| 2000: Hybrid fiber-reinforced composite | |
| material (second embodiment) | |
| 2100: first thermosetting resin | 2200: first continuous fiber layer |
| 2300: long fiber layer | 2400: second continuous fiber layer |
| 2500: second thermosetting resin | |

What is claimed is:

1. A hybrid fiber-reinforced composite material comprising a first long fiber layer, a continuous fiber layer laminated on one surface of the first long fiber layer, and a second long fiber layer laminated on one surface of the continuous fiber layer, and further comprising at least one of a first thermosetting resin laminated on the other surface of the first long fiber layer and a second thermosetting resin laminated on one surface of the second long fiber layer.

2. The hybrid fiber-reinforced composite material of claim 1, wherein the first thermosetting resin and the second thermosetting resin each include at least one of epoxy, unsaturated polyester, and vinyl ester.

3. The hybrid fiber-reinforced composite material of claim 1, wherein the first long fiber layer and the second long fiber layer each have a thickness of 0.3 to 1 mm, and the continuous fiber layer has a thickness of 0.3 to 0.7 mm.

4. The hybrid fiber-reinforced composite material of claim 1, wherein the first long fiber layer, the continuous fiber layer, and the second long fiber layer each comprise at least one of glass fiber and carbon fiber.

5. The hybrid fiber-reinforced composite material of claim 4, wherein the hybrid fiber-reinforced composite material has a basis weight of 1,000 to 4,000 gsm, and the at least one of glass fiber and carbon fiber has a weight ratio of 25 to 70% of the hybrid fiber-reinforced composite material.

6. A hybrid fiber-reinforced composite material comprising a first continuous fiber layer, a long fiber layer laminated on one surface of the first continuous fiber layer, and a second continuous fiber layer laminated on one surface of the long fiber layer, and further comprising at least one of a first thermosetting resin laminated on the other surface of the first continuous fiber layer and a second thermosetting resin laminated on one surface of the second continuous fiber layer.

7. The hybrid fiber-reinforced composite material of claim 6, wherein the first thermosetting resin and the second thermosetting resin each include at least one of epoxy, unsaturated polyester, and vinyl ester.

8. The hybrid fiber-reinforced composite material of claim 6, wherein the long fiber layer has a thickness of 0.3 to 1 mm, and the first continuous fiber layer and the second continuous fiber layer each have a thickness of 0.3 to 0.7 mm.

9. The hybrid fiber-reinforced composite material of claim 6, wherein the first long fiber layer and the second long fiber layer each comprise at least one of glass fiber and carbon fiber.

10. The hybrid fiber-reinforced composite material of claim 9, wherein the hybrid fiber-reinforced composite material has a basis weight of 1,000 to 4,000 gsm, and the at least one of glass fiber and carbon fiber has a weight ratio of 25 to 70% of the hybrid fiber-reinforced composite material.

11. An apparatus for manufacturing a hybrid fiber-reinforced composite material including:
a first thermosetting resin supply unit for discharging a first thermosetting resin;
a first long fiber supply unit for supplying a first long fiber to the top portion of the first thermosetting resin;
a continuous fiber supply unit including a supply roll for supplying a continuous fiber to the top portion of the first long fiber;
a second long fiber supply unit for supplying a second long fiber to the top portion of the continuous fiber;
a second thermosetting resin supply unit for supplying a second thermosetting resin to the top portion of the second long fiber;
a conveying belt unit for moving them so that the first thermosetting resin, the first long fiber, the continuous fiber, the second long fiber, and the second thermosetting resin are sequentially stacked; and
a winding roll unit for receiving and winding a composite material composed of the first thermosetting resin, the first long fiber, the continuous fiber, the second long fiber, and the second thermosetting resin, which are sequentially stacked, from the conveying belt unit.

12. The apparatus of claim 11, wherein the first long fiber supply unit and the second long fiber supply unit each include a support roll for supporting a glass fiber or carbon fiber roving and a cutting roll for cutting the glass fiber or carbon fiber roving.

13. The apparatus of claim 11, wherein the conveying belt unit includes a belt for moving them so that the first thermosetting resin, the first long fiber, the continuous fiber, the second long fiber, and the second thermosetting resin are sequentially stacked and a transfer for providing a driving force to the belt.

14. The apparatus of claim 13, wherein the conveying belt unit further includes a pressurizing and supporting roll for pressurizing the second thermosetting resin supplied and stacked by the second thermosetting resin supply unit.

15. An apparatus for manufacturing a hybrid fiber-reinforced composite material including:
a first thermosetting resin supply unit for discharging a first thermosetting resin;
a first continuous fiber supply unit including a supply roll for supplying a first continuous fiber to the top portion of the first thermosetting resin;
a long fiber supply unit for supplying a long fiber to the top portion of the first continuous fiber;
a second continuous fiber supply unit including a supply roll for supplying a second continuous fiber to the top portion of the long fiber;
a second thermosetting resin supply unit for supplying a second thermosetting resin to the top portion of the second continuous fiber;
a conveying belt unit for moving them so that the first thermosetting resin, the first continuous fiber, the long fiber, the second continuous fiber, and the second thermosetting resin are sequentially stacked; and
a winding roll unit for receiving and winding a composite material composed of the first thermosetting resin, the first continuous fiber, the long fiber, the second continuous fiber, and the second thermosetting resin, which are sequentially stacked, from the conveying belt unit.

16. The apparatus of claim 15, wherein the long fiber supply unit includes a support roll for supporting a glass fiber or carbon fiber roving and a cutting roll for cutting the glass fiber or carbon fiber roving.

17. The apparatus of claim 15, wherein the conveying belt unit includes a belt for moving them so that the first thermosetting resin, the first continuous fiber, the long fiber, the second continuous fiber, and the second thermosetting resin are sequentially stacked and a transfer roll for providing a driving force to the belt.

18. The apparatus of claim 17, wherein the conveying belt unit further includes a pressurizing and supporting roll for pressurizing the second thermosetting resin supplied and stacked by the second thermosetting resin supply unit.
